(19) United States
(12) Patent Application Publication
(10) Pub. No.: US 2024/0085346 A1
(43) Pub. Date: Mar. 14, 2024

(54) INSECTICIDE DETECTION DEVICE

(71) Applicant: Liverpool John Moores University, Liverpool (GB)

(72) Inventors: Patryk Kot, Port Sunlight (GB); Andy Shaw, Ormskirk (GB); Magomed Muradov, Liverpool (GB); Rinki Deb, Liverpool (GB); Michael Coleman, Formby (GB); Janet Hemingway, Cholmondeston (GB)

(21) Appl. No.: 18/466,557

(22) Filed: Sep. 13, 2023

(30) Foreign Application Priority Data
Sep. 14, 2022 (GB) 22 13480.3

(51) Int. Cl. G01N 22/00

(52) U.S. Cl. CPC G01N 22/00

(57) ABSTRACT

An insecticide detection device (10) comprising: microwave circuitry (22) for generating a microwave signal; an antenna (26) for transmitting the microwave signal towards a surface (12); a power detector (28) for receiving a reflected microwave signal from the surface (12); and an insecticide dosage level indicator (46) to indicate a detected insecticide dosage level on the surface (12), wherein the detected insecticide dosage level is dependent upon the reflected microwave signal.

### TECHNICAL FIELD

The present disclosure relates to an insecticide detection device and method of operating an insecticide detection device. In particular, but not exclusively, it relates to a portable insecticide detection device for in-situ detection of insecticide on a surface and a method of operating a portable insecticide detection device to detect insecticide on a surface.

Aspects of the invention relate to an insecticide detection device and a method of operating an insecticide detection device.

### BACKGROUND

Tropical infectious diseases, such as malaria, dengue, zika and leishmaniasis are of global public health importance. These diseases affect millions, malaria alone accounted for 214 million new cases resulting in 438,000 deaths in 2015.

Spread by the infectious bite of arthropod insect vectors, namely mosquitoes and sand flies, the main strategies to control and eliminate such diseases are insecticide based strategies: indoor residual spraying (IRS) and long-lasting insecticide nets (LLINs). Such interventions aim to kill the vector and therefore interrupt the disease transmission cycle; however, resistance to the insecticides available for public health use is of growing concern.

The World Health Organisation (WHO) have set process, performance and impact indicators, which should be monitored during each round of a vector control intervention. Quality assurance (QA) forms an essential component of performance monitoring, including validation that the correct dose of insecticide is delivered in any vector control intervention. However, for many programmes performing QA is costly and logistically challenging.

For IRS, the current gold standard method to quantify insecticide deposited is carrying out high performance liquid chromatography (HPLC) on filter papers that were affixed to walls prior to IRS. Together with surveys monitoring insecticide efficacy and the residual decay rate, this provides a comprehensive understanding of the operational impact of IRS. However, these methods can be time consuming and require insectaries with susceptible colonies, laboratories, expensive equipment, and skilled technicians. Furthermore, IRS operators can become sensitised to QA methods used and focus spray efforts on filter papers, providing artificial results. Alternative methods such as the Insecticide Quantification Kit (IQK) have been developed and used in a few field surveys.

It is an aim of the present invention to address at least some of the disadvantages associated with the prior art.

### SUMMARY OF THE INVENTION

Aspects and embodiments of the invention provide an insecticide detection device and a method of operating an insecticide detection device.

According to an aspect of the invention there is provided an insecticide detection device comprising: microwave circuitry for generating a microwave signal; an antenna for transmitting the microwave signal towards a surface; a power detector for receiving a reflected microwave signal from the surface; and an insecticide dosage level indicator to indicate a detected insecticide dosage level on the surface. An advantage of the invention is that non-destructive in-situ measurements of an insecticide on a surface can be carried out to indicate, in real-time, a dosage level of the insecticide on that surface without recourse to laboratory testing of samples taken from the surface. The detected insecticide dosage level is dependent upon the reflected microwave signal.

The insecticide to be detected may be alpha cypermethrin.

The antenna may be a resonant patch antenna. The resonant patch antenna may be capable of transmitting and receiving an electromagnetic signal, for example a microwave signal. The transmitted microwave signal may have a frequency between 2.6 GHz and 3.1 GHz.

The insecticide dosage level indicator may comprise a display to visually indicate the detected insecticide dosage level. An advantage of this feature is that the user of the insecticide detection device can readily observe, in real-time, the dosage level of the insecticide on the surface, without the need to process the data externally to the device.

The display may comprise one or more light emitting device to indicate the detected insecticide dosage level. An advantage of this feature is that a simplistic indication can be given to an operator of the insecticide detection device as to whether the detected insecticide dosage level is above or below a threshold level.

The display may comprise a plurality of light emitting devices to indicate different levels of detected insecticide dosage. An advantage of this feature is that the operator of the insecticide detection device can be provided with an indication of the deviation in insecticide dosage level from a predetermined value in order to indicate whether further application of insecticide is required on the surface.

The insecticide dosage level indicator may comprise an audible indicator to audibly indicate a detected insecticide dosage level. The audible indicator may audibly indicate different levels of detected insecticide dosage. An advantage of this feature is that the insecticide dosage level indicator is not affected by the visual environment, for example it can be used where the light level in the environment would make a visual indicator difficult to read.

The insecticide detection device may comprise a proximity sensor to detect proximity of the insecticide detection device to the surface. The proximity sensor may initiate transmission of the microwave signal towards the surface. An advantage of this feature is that the insecticide detection device does not use power to transmit microwave signals until the insecticide detection device is in-situ and ready to take measurements from a surface. This may provide the advantage of allowing the insecticide detection device to be battery powered and portable, where the feature of the proximity sensor initiating transmission of the microwave signal extends the battery life of the device.

The proximity sensor may comprise a pressure sensor to detect abutment of the insecticide detection device to the surface and to initiate transmission of the microwave signal towards the surface. An advantage of this feature is that the location of the insecticide detection device relative to the surface when taking measurements is reliably repeatable, whilst minimising errors due to variation in the separation of the insecticide detection device and the surface.

The insecticide detection device may utilise a logistic regression algorithm to perform multiclass classifications for a number of insecticide concentrations and determine the insecticide concentration with the highest probability. The insecticide concentration with the highest probability may be used to determine the detected insecticide dosage level on the surface.

The insecticide detection device may comprise a storage means, wherein the detected insecticide dosage level and/or the reflected microwave signal is stored in the storage means. An advantage of this feature is that data can be stored on the device for later processing.

The insecticide detection device may comprise a communication means to communicate with an external device, wherein the detected insecticide dosage level and/or the reflected microwave signal can be transmitted to the external device for further processing or storage. An advantage of this feature is that the device can be portable whilst maintaining the ability to be associated with further computing means for logging and/or analysis of data.

According to an aspect of the invention there is provided a method of operating an insecticide detection device comprising: generating a microwave signal using microwave circuitry; transmitting the microwave signal towards a surface via an antenna; receiving, at a power detector, a reflected microwave signal from the surface; and indicating, via an insecticide dosage level indicator, a detected insecticide dosage level on the surface, wherein the detected insecticide dosage level is dependent upon the reflected microwave signal. An advantage of the invention is that non-destructive in-situ measurements of an insecticide on a surface can be carried out to indicate, in real-time, a dosage level of the insecticide on that surface without recourse to laboratory testing of samples taken from the surface.

The method of operating an insecticide detection device may comprise: determining the proximity of the insecticide detection device to the surface; and initiating transmission of the microwave signal towards the surface when the insecticide detection device is determined to be within a predetermined threshold distance from the surface. An advantage of this feature is that the insecticide detection device does not use power to transmit microwave signals until the insecticide detection device is in-situ and ready to take measurements from a surface. This may provide the advantage of allowing the insecticide detection device to be battery powered and portable, where the feature of the proximity sensor initiating transmission of the microwave signal extends the battery life of the device.

The method of operating an insecticide detection device may comprise: performing multiclass classifications for a number of insecticide concentrations using a logistic regression algorithm; and determining the insecticide concentration with the highest probability, the insecticide concentration with the highest probability being used to determine the detected insecticide dosage level on the surface.

The method of operating an insecticide detection device may comprise: storing the detected insecticide dosage level and/or the reflected microwave signal in a storage means. An advantage of this feature is that data can be stored on the device for later processing.

The method of operating an insecticide detection device may comprise: transmitting the detected insecticide dosage level and/or the reflected microwave signal, via a communication means, to an external device for further processing or storage. An advantage of this feature is that the device can be portable whilst maintaining the ability to be associated with further computing means for logging and/or analysis of data.

Within the scope of this application, it is expressly intended that the various aspects, embodiments, examples, and alternatives, set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic view of an insecticide detection device according to an embodiment of the invention; and

FIG. 2 is a flow diagram of the operation of an insecticide detection device according to an embodiment of the invention.

In the drawings, like parts are denoted by like reference numerals.

### DETAILED DESCRIPTION

Examples of the present disclosure relate to an insecticide detection device and method of operation of an insecticide detection device. In particular, examples of the present disclosure relate to an insecticide detection device utilising the reflection of microwave signals for detecting insecticide on a surface. Non-limiting examples will now be described with reference to the accompanying drawings.

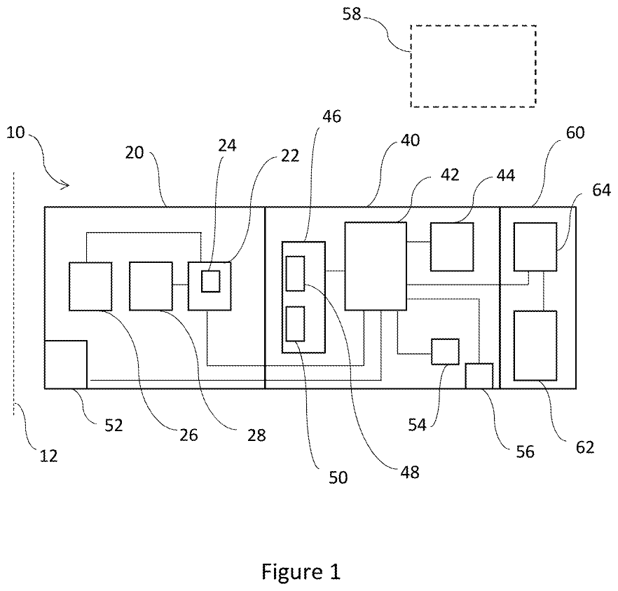

FIG. 1 illustrates one embodiment of an insecticide detection device 10 having a microwave generation and transmission section 20, a controller section 40, and a power section 60. FIG. 1 illustrates an embodiment which comprises a number of features which may be omitted whilst still falling within the claimed invention, as will be apparent from the description of the components of the insecticide detection device 10 below.

The microwave generation and transmission section 20 comprises microwave circuitry 22 for generating a microwave signal. The microwave circuitry 22 comprises a microwave voltage-controlled oscillator (VCO) 24 for the generation of microwave signals. The generation of microwave signal may consume a low level of power, in some examples using less than 10 mW to generate the desired microwave signal. The generated microwave signals are non-ionizing and are therefore safe for the operator or user of the device and other persons in the vicinity of the insecticide detection device 10 when in operation. The microwave generation and transmission section 20 also comprises an antenna 26 for transmitting the generated microwave signal towards a surface 12. The surface 12 may be formed of various building materials and may be, for example, the walls, floors and ceilings of a building. In some embodiments, the antenna 26 may be a resonant patch antenna, though it will be understood that various antenna structures may be used to transmit and receive microwave signals, including, wire antennas, aperture antennas, cavity and microstrip antennas. Various types of aperture antennas may be used such as pyramidal horn, conical horn or rectangular waveguide antennas.

In some embodiments, the transmitted microwave signal may have a frequency between 1.0 GHz and 4.0 GHz, and preferably between 2.6 GHz and 3.1 GHz. Such microwave frequencies are particularly useful in the detection of the insecticide alpha cypermethrin, which is an insecticide commonly applied to the walls of buildings in areas affected by tropical infectious diseases, such as malaria, dengue, zika and leishmaniasis which are transmitted by the infectious bite of arthropod insect vectors, namely mosquitoes and sand flies.

Other types of insecticides may be detected by the insecticide detection device 10 and it will be understood that a variation in insecticide to be detected may require a variation in the microwave frequency generated and antenna structure used by the microwave circuitry 22 to be transmitted to the surface 12 via the antenna 26.

The microwave generation and transmission section 20 also comprises a power detector 28 for receiving a reflected, or backscattered, microwave signal from the surface 12.

The controller section 40 comprises controller circuitry 42. The controller circuitry 42 may be in the form of a processor or microcontroller.

The controller circuitry 42 is connected to storage means 44. The storage means 44 may be in the form of a memory or memory circuitry, such as an EEPROM, for storage of processing instructions and data. The detected insecticide dosage level and/or the reflected or backscattered microwave signal, received by the power detector 28 can be stored on the storage means 44. Multiple storage means 44 can be provided to segregate the processing instructions from stored data. The storage means 44 for data may be provided in the form of removable memory circuitry, such as a Secure Digital (SD) card or a flash drive, enabling the data to be taken from the insecticide detection device 10 to be analysed on another device, such as a computing device.

The controller section 40 further comprises an insecticide dosage level indicator 46 to indicate a detected insecticide dosage level on the surface 12, where the detected insecticide dosage level is dependent upon the reflected or backscattered microwave signal received at the power detector 28 from the surface 12.

The insecticide dosage level indicator 46 may comprise a display 48 to visually indicate the detected insecticide dosage level. The display 48 may comprise one or more light emitting device to indicate the detected insecticide dosage level. The light emitting devices may be, for example, light emitting diodes (LEDs).

In some embodiments, only one light emitting device is provided on the display 48, such that the insecticide dosage level indicator 46 is capable of indicating, for example by being illuminated, when the detected insecticide dosage level is above a predetermined threshold value. The predetermined threshold value may be stored in the storage means 44 and used by the controller circuitry 42 to determine whether a detected insecticide dosage level is equal to or greater than the predetermined threshold level.

In alternative embodiments, the display 48 may comprise a plurality of light emitting devices to indicate different levels of detected insecticide dosage.

In one example embodiment three light emitting devices can represent the category levels, very low, low, correct, high, and very high by being illuminated in particular combinations. For example, when the detected insecticide dosage level is determined to be very low, only a first light emitting device is illuminated. When the detected insecticide dosage level is determined to be low, then the first light emitting device and a second light emitting device are illuminated. When the detected insecticide dosage level is determined to be correct, that is at or within a range of a predetermined ideal dosage level, only the second light emitting device is illuminated. When the detected insecticide dosage level is determined to be high, the second light emitting device and a third light emitting device are illuminated. When the detected insecticide dosage level is determined to be very high, only the third light emitting device is illuminated.

In another example embodiment, five light emitting devices may be provided to indicate different levels of detected insecticide dosage, for example by having each light emitting device separately representing the category levels, very low, low, correct, high, and very high.

In order to optimise the visual representation of the detected insecticide dosage level, different colour light emitting devices, or variable colour light emitting devices, may be used. For example, the different colour, or variable colour, light emitting devices may illuminate green, amber or red. Various combinations of the number and colour of the light emitting devices may be provided, whilst representing a number of different category levels for different levels of insecticide dosage.

In an alternative embodiment, a numeric display 48 may indicate a level of insecticide detected. For example, a level of insecticide may be displayed in mg/m 2.

Alternatively, or in addition to the visual representation of the detected insecticide dosage level, the insecticide dosage level indicator may comprise an audible indicator 50 to audibly indicate a detected insecticide dosage level. The audible indicator 50 may comprise a speaker. An audible tone may be emitted by the audible indicator 50 to indicate that insecticide dosage level is above a predetermined threshold value. The predetermined threshold value may be stored in the storage means 44 and used by the controller circuitry 42 to determine whether a detected insecticide dosage level is equal to or greater than the predetermined threshold level.

The audible indicator 50 may audibly indicate different levels of detected insecticide dosage. For example, the audible indicator 50 may provide audible announcements such as “very low”, “low”, “correct”, “high”, and “very high”, or may provide different tones to indicate different levels of detected insecticide levels.

The insecticide detection device 10 may comprise a proximity sensor 52 in order to detect proximity of the insecticide detection device 10 to the surface 12. The proximity sensor 52 may initiate or trigger transmission of the microwave signal towards the surface 12. The proximity sensor may provide proximity data without contact with the surface, for example by the use of a non-contact sensor. Example non-contact sensors capable of being used in the insecticide detection device 10 include infra-red sensors, capacitive sensors, optical sensors, or ultrasonic sensors.

The proximity sensor 52 may alternatively comprise a contact sensor, for example a pressure sensor, which may be in the form of a switch, located on the front of the insecticide detection device 10, to detect the proximity of the insecticide detection device 10 to the surface 12, by abutment of the pressure sensor on the surface 12. The abutment of the pressure sensor on the surface 12 may initiate or trigger transmission of the microwave signal towards the surface 12, for example by providing a signal to the microwave circuitry 22 or to the controller circuitry 42 which may then provide a signal to the microwave circuitry 22 to initiate the transmission of the microwave signal. A benefit of using a contact sensor is that power consumption for such a sensor is minimal or zero, and it is only activated during the contact with the surface 12, unlike non-contact proximity sensors, such that the portability of the device is not detrimentally affected when using such a contact sensor.

The controller section 40 of the insecticide detection device 10 may utilise a logistic regression algorithm to perform multiclass classifications for a number of insecticide concentrations, for example five insecticide concentrations, and determine the insecticide concentration with the highest probability. The insecticide concentration with the highest probability may be used to determine the detected insecticide dosage level on the surface 12.

The logistic regression algorithm provides quality assurance of the insecticide present on the surface 12. The logistic regression algorithm uses weighs or coefficients determined during training of the algorithm.

The logistic regression algorithm model is based on the logistic function which is also known as sigmoid function. The sigmoid function is an S-shaped function and takes any real values to map them in the interval between 0 and 1. The logistic regression model may consist of weights or coefficients and biases. During the training of the algorithm, the coefficients are updated based on the multiple epochs following error correction. For training purposes, a dataset may be split into training, validation and testing sets. The validation and test sets are used to improve the generalization of the developed model and test the prediction accuracy on new data. The trained algorithm is implemented on the insecticide detection device 10.

Trained coefficients are stored on the storage means 44 on the insecticide detection device 10 to be used by the controller circuitry 42 in the determination of the highest probability insecticide concentration. For example, the trained coefficients for five classes may be saved in an available storage means 44, such as a memory, on the insecticide detection device 10. The prediction carried out by the insecticide detection device 10 is made using these saved trained coefficients. The insecticide detection device 10 may take multiple readings before providing a final determination of the insecticide dosage level, or insecticide concentration, on the surface 12. For example, three readings may be taken and an average created before the insecticide dosage level, or insecticide concentration, on the surface 12, is determined. Alternatively, a majority result of the three readings may be reported on, or by, the insecticide detection device 10. Of course, in other embodiments, any plurality of readings may be taken and an average, or majority, result reported by the insecticide detection device 10.

The controller section 40 of the insecticide detection device 10 may comprise a communication means 54 to communicate with an external device 58, wherein the detected insecticide dosage level and/or the reflected microwave signal can be transmitted to the external device 58 for further processing or storage. Furthermore, stored data may be transmitted to the external device 58. The communication means 54 may be in the form of communication circuitry. The communication means 54 may be a Bluetooth device, WiFi device, Zigbee device, or other wireless communication means. Alternatively, the communication means 54 may provide communication via wired connection 56, such as an ethernet connection, a serial connection, or a Universal Serial Bus (USB) connection. The communication means 54, 56 may also be used to receive firmware updates for the insecticide detection device 10.

The power section 60 of the insecticide detection device 10 may provide suitable power for the operation of the of the insecticide detection device 10, and may comprise, or be capable of receiving, replaceable or rechargeable batteries 62. The power section 60 may have voltage conversion circuitry 64 to provide the correct voltage for operation of the electronic components of the insecticide detection device 10. It will be understood that in some embodiments the batteries may be selected to provide the correct voltage without voltage conversion. The use of batteries 62 enables the insecticide detection device 10 to be portable and to be used in remote locations where other sources of power may be unavailable.

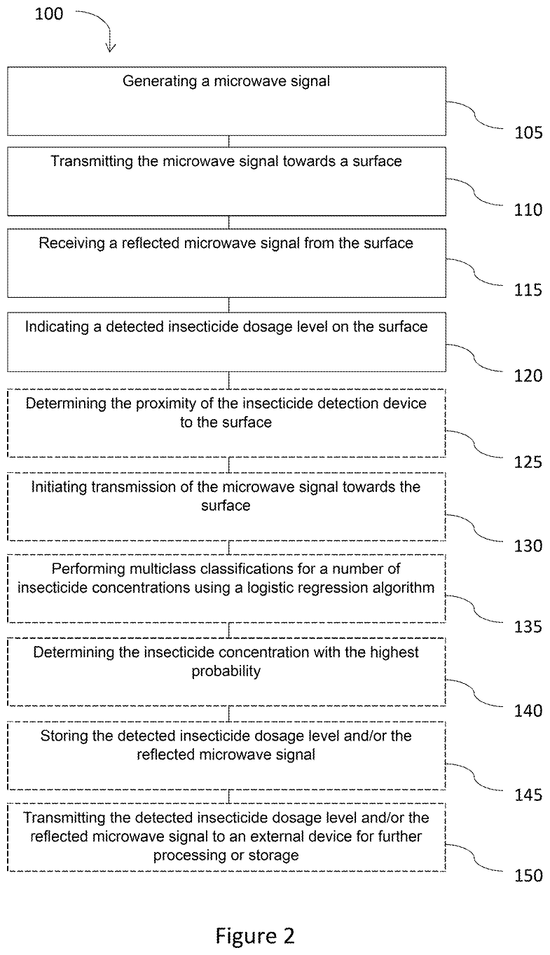

FIG. 2 illustrates the blocks of a method 100 for operating an insecticide detection device 10. FIG. 2 illustrates both essential features and optional features of the method.

The insecticide detection device 10 may be switched on and off using a power button located on the insecticide detection device 10.

As illustrated in FIG. 2, block 105 of method 100 comprises generating a microwave signal using microwave circuitry 22.

In block 110, the microwave signal is transmitted towards a surface 12 via an antenna 26, for example, a resonant patch antenna. Upon interaction with the surface 12, the microwave signal may be partially transmitted through the surface 12, partially absorbed within the surface 12, and partially reflected or backscattered from the surface 12.

In block 115 a reflected microwave signal is received, at a power detector 28, from the surface 12.

In block 120 an insecticide dosage level indicator 46 indicates a detected insecticide dosage level on the surface 12, wherein the detected insecticide dosage level is dependent upon the reflected or backscattered microwave signal.

Optionally, in block 125 the proximity of the insecticide detection device to the surface 12 is determined, and in block 130 transmission of the microwave signal towards the surface 12 is initiated when the insecticide detection device 10 is determined to be within a predetermined threshold distance from the surface 12. In particular, when it is determined that the insecticide detection device 10 is within a predetermined threshold distance from the surface 12, for example by pressure exerted on or detected by a pressure sensor, the controller section 40 of the insecticide detection device 10 is caused to activate. The controller section 40 of the insecticide detection device 10 then sends a control signal to the microwave generation and transmission section 20 to initiate generation of a microwave signal.

Optionally, in block 135 multiclass classifications are performed for a number of insecticide concentrations using a logistic regression algorithm.

Optionally, in block 140, the insecticide concentration with the highest probability is determined, the insecticide concentration with the highest probability being used to determine the detected insecticide dosage level on the surface.

Optionally, in block 145, the detected insecticide dosage level and/or the reflected microwave signal is stored in a storage means 44.

Optionally, in block 150 the detected insecticide dosage level and/or the reflected microwave signal is transmitted, via a communication means 54, to an external device 58 for further processing or storage.

Whilst the embodiments described above have described detection of certain insecticides using particular microwave frequencies, it will be understood that different insecticides may be detected using other microwave frequencies.

The blocks illustrated in FIG. 2 may represent steps in a method. The illustration of a particular order to the blocks does not necessarily imply that there is a required or preferred order for the blocks and the order and arrangement of the blocks may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An insecticide detection device comprising:
microwave circuitry for generating a microwave signal;
an antenna for transmitting the microwave signal towards a surface;
a power detector for receiving a reflected microwave signal from the surface; and
an insecticide dosage level indicator to indicate a detected insecticide dosage level on the surface, wherein the detected insecticide dosage level is dependent upon the reflected microwave signal.

2. An insecticide detection device according to claim 1, wherein the insecticide to be detected is alpha cypermethrin.

3. An insecticide detection device according to claim 1, wherein the antenna is a resonant patch antenna.

4. An insecticide detection device according to claim 1, wherein the transmitted microwave signal has a frequency between 2.6 GHz and 3.1 GHz.

5. An insecticide detection device according to claim 1, wherein the insecticide dosage level indicator comprises a display to visually indicate the detected insecticide dosage level.

6. An insecticide detection device according to claim 5, wherein the display comprises one or more light emitting device to indicate the detected insecticide dosage level.

7. An insecticide detection device according to claim 6, wherein the display comprises a plurality of light emitting devices to indicate different levels of detected insecticide dosage.

8. An insecticide detection device according to claim 1, wherein the insecticide dosage level indicator comprises an audible indicator to audibly indicate a detected insecticide dosage level.

9. An insecticide detection device according to claim 8, wherein the audible indicator audibly indicates different levels of detected insecticide dosage.

10. An insecticide detection device according to claim 1, comprising a proximity sensor to detect proximity of the insecticide detection device to the surface and to initiate transmission of the microwave signal towards the surface.

11. An insecticide detection device according to claim 10, wherein the proximity sensor comprises a pressure sensor to detect abutment of the insecticide detection device to the surface.

12. An insecticide detection device according to claim 1, wherein the insecticide detection device utilises a logistic regression algorithm to perform multiclass classifications for a number of insecticide concentrations and determines the insecticide concentration with the highest probability, the insecticide concentration with the highest probability being used to determine the detected insecticide dosage level on the surface.

13. An insecticide detection device according to claim 1, comprising a storage means, wherein the detected insecticide dosage level and/or the reflected microwave signal is stored in the storage means.

14. An insecticide detection device according to claim 1, comprising a communication means to communicate with an external device, wherein the detected insecticide dosage level and/or the reflected microwave signal can be transmitted to the external device for further processing or storage.

15. A method of operating an insecticide detection device comprising:
generating a microwave signal using microwave circuitry;
transmitting the microwave signal towards a surface via an antenna;
receiving, at a power detector, a reflected microwave signal from the surface; and
indicating, via an insecticide dosage level indicator, a detected insecticide dosage level on the surface, wherein the detected insecticide dosage level is dependent upon the reflected microwave signal.

16. A method of operating an insecticide detection device according to claim 15, comprising:
determining the proximity of the insecticide detection device to the surface; and
initiating transmission of the microwave signal towards the surface when the insecticide detection device is determined to be within a predetermined threshold distance from the surface.

17. A method of operating an insecticide detection device according to claim 15, comprising:
performing multiclass classifications for a number of insecticide concentrations using a logistic regression algorithm; and
determining the insecticide concentration with the highest probability, the insecticide concentration with the highest probability being used to determine the detected insecticide dosage level on the surface.

18. A method of operating an insecticide detection device according to claim 15, comprising:
storing the detected insecticide dosage level and/or the reflected microwave signal in a storage means.

19. A method of operating an insecticide detection device according to claim 15, comprising:
transmitting the detected insecticide dosage level and/or the reflected microwave signal, via a communication means, to an external device for further processing or storage.
